(19) United States
(12) Patent Application Publication
(10) Pub. No.: US 2011/0288265 A1
(43) Pub. Date: Nov. 24, 2011

(54) PLASTIC CONTAINERS AND CONDUITS

(76) Inventors: Eric W. Vegte Van Der, Buchten (NL); Johannes Hoekstra, Lieshout (NL)

(21) Appl. No.: 13/145,637

(22) PCT Filed: Jan. 21, 2010
(86) PCT No.: PCT/EP2010/050679

§ 371 Date: Jul. 21, 2011

(30) Foreign Application Priority Data
Jan. 21, 2009 (EP) 09000775.8

(51) Int. Cl. C08G 69/26; B65D 1/00; F17D 1/00; F16L 9/00

(52) U.S. Cl. 528/324; 138/177; 206/524.6; 528/338; 528/329.1; 137/1

(57) ABSTRACT

The invention relates to a plastic container or conduit for a cooling system, a heating system, an air intake system, an exhaust system, a pressure system or a fuel system, consisting of or comprising a part or a layer made of a thermoplastic polymer composition comprising a semi-crystalline semi-aromatic polyamide having a glass transition temperature (Tg) of at least 115° C.

The invention relates to a plastic container or conduit. More particular the invention relates to a container or conduit for a cooling system, a heating system, an air intake system, an exhaust system, a pressure system or a fuel system, consisting of, or comprising a part or a layer made of a thermoplastic polymer composition.

Containers and conduits for cooling systems, heating systems, air intake systems, exhaust systems, pressure systems and fuel systems are typically used in connection to engines, or heating devices, producing heat. Moreover, the engines are often confined in a compartment where the heat cannot always be released easily. This is the case for example for automotive engines confined under the engine hood. Because of the elevated temperatures in the close vicinity of a heating device or engine, the container, respectively the conduit, must have a good thermal stability, not only against short term peak temperatures, but in particular to long term exposure to elevated temperature. In particular when exposed for a long period to elevated temperature at relatively high humidity, the materials of which the container or conduit is made, may suffer from oxidative degradation, resulting in and visible from surface cracking. On the other hand several of the containers and conduits are used to store or transport liquids, such as oil, fuel, and heating and cooling liquids, such as water and water/glycol mixtures, etc. These liquids can be aggressive liquids for the plastic materials used in the containers and conduits, in particular at elevated temperature. Under such conditions so-called stress cracking may occur. Therefore, the containers and conduits should also be significantly impermeable to such liquids, and be sufficiently resistant to the liquids used, in particular to stress cracking at elevated temperature.

The aim of the present invention is to provide a plastic container or conduit, and materials used there, that combine a good resistance against elevated temperature at relatively high humidity, show a low permeability and a good resistance against environmental stress cracking under exposure against liquids such as oil, fuel, and heating and cooling liquids.

This aim has been achieved with the container and conduit according to the invention, wherein the container and conduit consists of, or comprises a part or a layer made of a polyamide polymer composition comprising a semi-crystalline semi-aromatic polyamide having a glass transition of at least 115° C.

It has been found that a container or conduit, or at least the part or layer thereof, made of the said composition combines good properties in respect of thermo-oxidative resistance, chemical resistance and fuel impermeability. Semi-crystalline polyamides have a melting temperature (Tm) which is typically is above the glass transition temperature (Tg) and which might be very high, and result in good dimensional properties and retention of mechanical properties at elevated temperatures. The Tg of such semi-crystalline polyamides may vary depending on the type of polyamide, and can be different for different polyamides having the same melting temperature. Amorphous semi-aromatic polyamides might have a much higher Tg than those used in the present invention, but the Tg is generally not sufficient for the required dimensional and mechanical properties at elevated temperatures. It has been found that semi-crystalline aliphatic polyamides generally have a much lower Tg, have higher fuel permeability and suffer much more from thermo-oxidation and environmental stress cracking under comparable conditions. In comparison with corresponding products made of some semi-crystalline semi-aromatic polyamides having a lower Tg, despite being semi-crystalline and having a comparable melting temperature, the products according to the invention show an overall good balance in properties, i.e. thermo-oxidative resistance at elevated temperature at relatively high humidity, chemical resistance and fuel impermeability.

WO2007/085406 describes semi-crystalline semi-aromatic polyamides with a high Tg, but not the effect thereof on the fuel permeability.

WO2006/056581 describes multilayered structures comprising semi-crystalline semi-aromatic polyamides, but does not neither describe semi-crystalline semi-aromatic polyamides with a high Tg nor the effect thereof on the fuel permeability

A conduit is herein understood a means for conducting a fluid or a gas, such as air. Such a conduit might suitably have the shape of a pipe or tube.

A container is herein understood a means for containing a fluid or a gas. Suitably, the container has one or more openings, suited for either separately or combined filling and/or releasing the fluid or gas.

A semi-aromatic polyamide is herein understood to have the regular meaning within the field of thermoplastic polymers. Such a polyamide typically comprises repeat units comprising aromatic moieties next to repeat units comprising aliphatic moieties. Generally, such a polyamide comprises repeat units derived from dicarboxylic acids and diamines, repeat units derived from other components may be present as well.

With a semi-crystalline polymer is herein understood a polymer having a melting enthalpy of at least 5 J/g. In line with that an amorphous polymer is herein understood to be a polymer having a melting enthalpy of less than 5 J/g.

With the term melting enthalpy is herein understood the exothermic energy, measured with the method according to ASTM D3418-03 by DSC in the second heating run with a heating rate of 10° C./min.

With the term melting temperature is herein understood the melting temperature, measured with the method according to ASTM D3418-03 by DSC in the second heating run with a heating rate of 10° C./min. Herein the maximum peak of the melting endotherm is taken as the melting temperature.

With the term glass transition temperature (Tg) used herein is understood the temperature, measured with the method according to ASTM E 1356-91 by DSC in the second heating run with a heating rate of 10° C./min, falling in the glass transition range and showing the highest glass transition rate. The temperature showing the highest glass transition rate is determined as the temperature at the peak of the first derivative (with respect of time) of the parent thermal curve corresponding with the inflection point of the parent thermal curve.

With the term density is herein understood the density at 20° C. measured with the method according to ISO 1183-1:2004 B Method B (liquid pyknometer method, for particles, powders, flakes, granules or small pieces of finished parts).

Unless expressly noted otherwise, amounts of ingredients are indicated herein in weight percentage (wt. %), wherein the weight percentages, unless expressly noted otherwise, are relative to the total weight of the composition comprising the ingredients.

The semi-crystalline semi-aromatic polyamide will herein also be denoted as polyamide (A) or just (A) for compactness and readability.

The properties of the polyamide (A) used in the thermoplastic polymer composition for the container or conduit according to the present invention may vary, although Polyamide (A) has specific preferred characteristics.

Preferably, the glass transition temperature of polyamide (A) is at least 120° C., more preferably at least 125° C., or even better at least 130° C. In particular the thermo-oxidative resistance at elevated temperature at relatively high humidity is increased.
Preferably polyamide (A) has a melting temperature (Tm-A) of at least 270° C., more preferably 290-340° C., and even better 310-330° C. A higher minimum melting temperature has the advantage that the dimensional and mechanical properties at elevated temperatures are better retained. A lower maximum melting temperature is that the products are more easily processed.

It has been found that polyamide (A) used for the preparation of the container or conduit according to the invention advantageously has a density, of at least 1.20. Preferably the density is at least 1.23. A higher density has been found favourable for a low permeability, good chemical resistance and oxidation stability. The density can be measured on the container or conduit after moulding, i.e. on the moulded part. If the composition in the moulded part comprises other components next to polyamide (A), the density is measured for the complete composition, from which the density of polyamide (A) is calculated by correction for the density of the other components. The properties of the moulded part according to the invention can be improved by subjecting the moulded part to an annealing step. Likewise through the annealing step, the crystallinity is enhanced and density increased.

Polyamide (A) may be any semi-crystalline semi-aromatic polyamide with a Tg of at least 115° C., Suitably, polyamide A comprises repeat units derived from dicarboxylic acids and diamines wherein either the dicarboxylic acids, or the diamines, or both, comprises aromatic components while the remainder comprises aliphatic dicarboxylic acids and/or diamines, which can linear, branched, or cyclic, and/or arylaliphatic dicarboxylic acids and diamines.

Examples of suitable aromatic dicarboxylic acids are terephthalic acid and isophthalic acid. Examples of suitable aromatic diamines are meta-xylylene diamine and para-xylylene diamine.

Preferably, the semi-crystalline semi-aromatic polyamide comprises repeat units derived from terephthalic acid as the dicarboxylic acids.

The aliphatic dicarboxylic acids and aliphatic diamines that can be used in the polyamide (A), in combination with the said aromatic dicarboxylic acids and/or aromatic diamines, may be any aliphatic dicarboxylic acid and/or aliphatic diamine. Suitably, the dicarboxylic acid components comprise 4-36 C atoms, preferably 6-12 C atoms. The dicarboxylic acid components may comprise 2-36 C atoms, preferably 4-12 C atoms.

Examples of aliphatic dicarboxylic acid that can be used in polyamide (A), optionally in combination with the said aromatic dicarboxylic acids, are adipic acid and 1,4-cyclohexaan dicarboxylic acid. Examples of aliphatic diamines are 1,4 butane diamine, 1,5 pentane diamine, 1,6 hexane diamine, 1,8 octane diamine, 2-methyl octamethylene diamine, 1,9 nonane diamine, 1,10 decane diamine,

In a preferred embodiment the semi-crystalline semi-aromatic copolyamide consists of repeat units derived from:
(a) 25-45 mole % terephthalic acid,
(b) 5-25 mole % of an aromatic dicarboxylic acid different from terephthalic acid, and/or an aliphatic dicarboxylic acid,
(c) 5-30 mole % of an diamine chosen from the group consisting of ethylene diamine, trimethylene diamine, tetramethylene diamine and pentamethylene diamine,
(d) 20-45 mole % of a diamine comprising at least 6 C-atoms, and optionally
(e) 0-10 mole % of one or more aminocarboxylic acids and or lactams, and
(f) 0-3 mole % of compounds being mono-functional or tri-functional in amino and/or carboxylic acid groups;
   wherein the mole % of each of a-f is relative to the total of a-f, and the total of a-f is 100%.

The advantage of this polyamide in the container and conduit is that it shows very good properties, likewise by the fact that it has a relative high density. Furthermore, this polyamide has a significant effect on the fuel permeability already when it is used in low amounts in combination with other polyamides.

Preferably, the short chain diamine (c) is chosen from tetramethylene diamine and pentamethylene diamine. Also preferably, the semi-crystalline semi-aromatic polyamide has a melting temperature in the range of 290-335 ° C., more preferably in the range of 310-330° C. A higher melting temperature can be accomplished e.g. by using a higher amount of terephthalic acid and/or alicyclic or aromatic diamines, or short chain aliphatic diamines. A higher Tg can be accomplished by using more short chain aliphatic diamines. The person skilled in the art can adapt the melting point using common general knowledge and routine experiments.

The components a-f in the said embodiment are preferably present, either individually or in combination with each other, in the following amounts: (a) 35-45 mole %; (b) 5-15 mole %; (c) 10-25 mole %; (d) 25-40 mole %; (e) 0-5 mole %; and (f) 0-1 mole %; wherein the mole % of each of a-f is relative to the total of a-f. Higher amounts of (a) and (d), relative to respectively (b) and (c) result in better processing for the polymer in combination with better high temperature properties.

The thermoplastic polymer composition in the container or conduit according to the invention may comprise next to polyamide (A), one or more other components, such as other polymers, reinforcing agents, fillers, and additives. Suitably, the thermoplastic polymer composition comprises at least one other polymer, and/or a reinforcing agent and/or a filler, and/or at least one other additive.

The other polymer may comprise, for example, a thermoplastic polymer, such as a polyamide or polyester, or an elastomer. Preferably, the other polymer comprises, or even consists of a polyamide different from the semi-crystalline semi-aromatic polyamide (A). This polyamide may be an aliphatic or semi-aromatic polyamide, an amorphous or crystalline polyamide, for example a semi-crystalline aliphatic polyamide, such as polyamide-6 or polyamide 66, or a semi-crystalline semi-aromatic polyamide with a Tg below 115° C. Preferably the other polyamide is a semi-crystalline polyamide.

As there might be at least one other polymer present, this is not necessarily the case. In that respect polyamide (A) might well be present in an amount of at least 40 wt %, preferably at least 50 or better 60 wt. %, still more preferably 75-100 wt. %, relative to the total weight of polymer present in the thermoplastic polymer composition.

As described above, already at very low amounts of polyamide (A) in combination with another polyamide, the fuel permeability can be significantly reduced. The polymer present in the thermoplastic polymer composition herein suitably comprises at least 60 wt. %, still more preferably 75-100 wt. %, of polyamide, relative to the total weight of polymer present in the thermoplastic polymer composition. The amount of polyamide (A) in the composition comprising the second polyamide can well be as low as 5 wt. %, in respect of the total weight of polymer present in the thermoplastic polymer composition. More preferably, the amount of polyamide (A) is at least 10 wt. %, more preferably is in the range of 20-95 wt. %, or even better 50-90 wt. %.

The reinforcing agents and fillers comprised by the composition may be any auxiliary reinforcing agent or filler used in moulding compounds. As the reinforcing agents fibres, may be used, such as glass fibres and carbon fibres. Fibres are herein defined as particles characterized by three dimensions denoted as thickness (t), length (l) and width (w), wherein the particles have an aspect ratio defined as the ratio between the length (l) and the largest of the width (w) and thickness (t), and expresses as l/(w or t), of at least 5.

Fillers that may be inorganic fillers, nanofillers, and so on. Preferably, the fillers comprise plate-like fillers, like talcum, mica and clays, preferably nanoclays. The advantage of platelike fillers is that the permeability to fuel and other liquids is further decreased. Platelike particles are herein defined as particles characterized by three dimensions denoted as thickness (t), length (l) and width (w), wherein the particles have an aspect ratio defined as the ratio between the smallest of the length (l) and width (w), and the thickness (t), and expresses as (l or w)/t, of at least 5. The reinforcing agents and fillers can be used in a combined amount varying over a wide range, e.g. from 0.1 to 60 wt. %. The amount may be even higher than 60 wt. %, or lower than 0.1 wt %. Although lower and higher amounts may be used, the combined amount of reinforcing agents and fillers, if used anyway, is preferably in the range of 5-40 wt. %.

However, platelike fillers are typically used in much lower amounts, varying e.g. from 0.1 to 10 wt. %, preferably 1-5 wt. %.

For the additives any auxiliary additive normally used for polyamide moulding compositions can be used. Additives that can be used in the composition include processing aids, like lubricants and release agents, stabilizers, like UV stabilizers and in particular heats stabilizers and anti-oxidants, colorants like pigments and dies, nucleating agents, etc. The mentioned and further suitable additives are described, for example in Gachter, Muller, Kunststoff-Additive, 3. Ausgabe, Hanser-Verlag, München, Wien, 1989 and in Plastics Additives Handbook, 5th Edition, Hanser-Verlag, München, 2001.

The additives can be used alone or in any combination thereof. The composition may comprise the additive or additives in an amount varying over a wide range. Suitably, the amount is in the range of 0.01-10 wt. %, preferably 0.1-5 wt. %, or even 0.2-2 wt. %.

In a particular embodiment, the thermoplastic polymer composition consists of
(a) 20-99.99 wt. % of the semi-crystalline semi-aromatic polyamide (A),
(b) 0-40 wt. % of at least one other polymer,
(c) 0-50 wt. % of fillers and/or reinforcing agents,
(d) 0.01-10 wt. % of additives,
   wherein the polyamide (A) is present in an amount of at least 50 wt %, relative to the total weight of (a) and (b), and wherein the weight percentages of (a)-(d) are relative to the total weight of the composition. The sum of (a)-(d) is equal to 100%.
   More particular, the thermoplastic polymer composition may consists of
(e) 50-99.95 wt. % of the semi-crystalline semi-aromatic polyamide (A),
(f) 0-25 wt. % of at least one other polymer,
(g) 0- 50wt. % of fillers and/ or reinforcing agents,
(h) 0.05-5 wt. % of additives.

The container or conduit according to the invention comprises at least a part or layer made from the thermoplastic polymer composition described above. In a specific embodiment, the container or conduit consists of a monolayer made from the thermoplastic polymer composition, or comprises at least two layers comprising a layer made from the thermoplastic polymer composition and at least one layer consisting of a polymer composition different from the thermoplastic polymer composition.

The at least one layer consisting of a polymer composition different from the thermoplastic polymer composition, is denoted herein also as other polymeric layer, or layers, where applicable.

Suitably, the layer of the made from the thermoplastic polymer composition, is combined with another barrier layer, e.g. an EVOH barrier layer.

The invention also relates to a process for the production of a container or conduit for a cooling system, a heating system, an air intake system, an exhaust system, a pressure system or a fuel system. The process according to the invention comprises a melt processing step wherein a thermoplastic polymer composition is heated and melt-shaped into a container or conduit shape. wherein the thermoplastic polymer composition comprises a semi-crystalline semi-aromatic polyamide having a glass transition of at least 115° C. The thermoplastic polymer composition and the semi-crystalline semi-aromatic polyamide used therein may be any particular or preferred embodiment as described here above.

The invention also relates to the use of a container or conduit according to the invention in a cooling system, a heating system, an air intake system, an exhaust system, a pressure system or fuel system. Herein, the cooling system, the heating system, the air intake system, the exhaust system, the pressure system or the fuel system may well be part of an automotive engine. The container or conduit may also be in direct contact with hot air, water, cooling liquid (e.g. water/glycol mixtures), oil, or fuel.

Suitably the plastic container according to the invention is a fuel tank, or a tank for a cooling liquid.

The plastic conduit according to the invention can be, for example, a tube, pipe or hose for heating and or cooling liquids, hydrolic liquids, or a part of a air inlet system or a part for an gas exhaust system.

The invention also relates to a heating device or fuel system comprising such a component not being a container or conduit, made of a thermoplastic polymer composition comprising a semi-crystalline semi-aromatic polyamide having a glass transition of at least 115° C.

The invention further relates to a component for a heating device or fuel system, wherein the component is a door handle, a door trim, a housing, a wall panel or a part thereof, a pump element.

The invention is further illustrated with the following examples and comparative experiments.

### Materials

PA-1 Polyamide 6T/4T/66, semi aromatic copolyamide, Tm 325C, Tg 125° C., RV 1.9
PA-2 Polyamide 6, aliphatic polyamide, Tm 220° C., Tg 51 ° C., RV=3.2
PA-3 Polyamide 6T/66, semi aromatic copolyamide, Tm 320° C., Tg 100° C., RV 2.6

Each of the polyamide compositions comprised around 0.5-1.0 wt. % of a standard additive package comprising processing aids and heat stabilizers. Melting temperature (Tm), glass transition temperature (Tg) and relative viscosity (RV) mentioned herein were measured by the methods described below.

### DSC Measurements: Tm and Tm

The melting temperature (Tm) was measured according to ASTM D3418-03 by DSC in the second heating run with a heating rate of 10° C./min.

The glass transition temperature (Tg) was measured according to ASTM E 1356-91 by DSC in the second heating run with a heating rate of 10° C./min, falling in the glass transition range and showing the highest glass transition rate.

### Mechanical Properties

The mechanical properties tensile strength [MPa] and elongation at break [%]) were measured in a tensile test according to ISO 527 at 23° C. The mechanical properties were measured on 70 μm thick films.

### Sample Preparation

Samples of 1 mm thick were prepared by melt extrusion moulding using standard extrusion and moulding conditions. The 1 mm thick samples were used for the fuel permeability tests. The following samples were prepared.

| Samples | Polymer |
|---|---|
| Example I. | PA-1 |
| Example II | PA-1/PA-2 blend 20/80 |
| Comparative Experiment A | PA-2 |

70 μm thick films were produced by melt extrusion through a slit die using a cold quenching role. The 70 μm thick films were used for the ageing experiments and oxygen permeation. The following samples were prepared.

| Samples | Polymer |
|---|---|
| Example III. | PA-1 |
| Example IV. | PA-1/PA-2 blend 80/20 |
| Comparative Experiment B | PA-3 |
| Comparative Experiment C | PA-2 |

### Fuel Permeation

The fuel permeation was measured on 1 mm thick plaques for CE10 fuel. The solubility and diffusion was measured using a standard method and based on that the permeability was calculated and rated against PA6 as a standard. Herein each of the calculated permeability values was divided by the value of PA6. Thus, PA6 was rated 1. The results are shown in Table 1.

TABLE 1
Diffusion, solubility and permeability
of 1 mm thick plaques for CE10 fuel

| Material | EX-I | EX-II | CE-A |
|---|---|---|---|
| Relative | 0.07 | 0.52 | 1 |
| permeability | | | |
| to PA6 | | | |

### Heat Ageing

The materials were tested under prolonged exposure to elevated temperature (85° C.) under dry conditions and to elevated temperature (85° C.) under wet conditions (85% RH). Before and after ageing the mechanical properties were measured. The test results are shown in Table 2.

TABLE 2
Mechanical properties before and after heat ageing.

| | Ageing Time | | |
|---|---|---|---|
| | (hrs) | EX-III | CE-B |
| Initial properties | | | |
| Tensile strength MPa | 0 | 73 | 57 |
| Elongation at break [%] | 0 | 192 | 202 |
| Ageing temp 85° C. | | | |
| Tensile strength MPa | 2016 | 69 | 52 |
| Elongation at break [%] | 2016 | 172 | 132 |
| Ageing temp 85° C./85% RH | | | |
| Tensile strength MPa | 1008 | 79 | 59 |
| Elongation at break [%] | 1008 | 117 | 36 |

### Oxygen Permeability Test

The oxygen permeability was measured on film samples using standard testing procedures.

Films of examples III and IV and Comparative Experiment C were subjected to an oxygen permeability test and the observed permeabilities for examples III and IV were normalized against that of Comparative Experiment C. Compared to the normalized value of 1 for Comparative Experiment C, the films of examples III and IV had a much lower oxygen permeability, which differed only slightly from each other: 0.25 against 0.26. Apparently the semi-crystalline polyamide PA-1 in example III showed a much lower oxygen permeability than the aliphatic polyamide PA-6 in Comparative Experiment C. Despite the presence of 20 wt. % PA-2 in the blend of example IV, the low oxygen permeability of PA-1 was hardly affected, at least in much lower extend than could be anticipated on a weight basis.

1. Conduit for a cooling system, a heating system, an air intake system, an exhaust system, a pressure system or a fuel system, consisting of, or comprising a part or a layer made of a thermoplastic polymer composition comprising a semi-crystalline semi-aromatic polyamide having a glass transition temperature (Tg) of at least 115° C.

2. Conduit according to claim 1, wherein the semi-crystalline semi-aromatic polyamide (A) has a glass transition temperature of at least 120° C., and/or the a melting temperature (Tm-A) of at least 270° C., and/or a density, of at least 1.20.

3. Conduit according to claim 1, wherein the semi-crystalline semi-aromatic polyamide (A) consists of repeat units derived from:
(a) 25-45 mole % terephthalic acid,
(b) 5-25 mole % of an aromatic dicarboxylic acid different from terephthalic acid, and/or an aliphatic dicarboxylic acid
(c) 5-30 mole % of an diamine chosen from the group consisting of ethylene diamine, trimethylene diamine, tetramethylene diamine and pentamethylene diamine
(d) 20-45 mole % of a diamine comprising at least 6 C-atoms, and optionally
(e) 0-10 mole % of one or more aminocarboxylic acids and/or lactams, and
(f) 0-3 mole % of one or more compounds being mono-functional or tri-functional in amino and /or carboxylic acid groups;
wherein the mole % of each of a-f is relative to the total of a-f, and the total of a-f is 100%.

4. Conduit according to claim 1, wherein the thermoplastic polymer composition comprises at least one other polymer, and/or a reinforcing agent, and/or a filler, and/or at least one other additive.

5. Conduit according to claim 1, wherein thermoplastic polymer composition consists of
(A) 40-95 wt. % of the semi-crystalline semi-aromatic polyamide,
(B) 0-40 wt. % of a at least one other polymer
(C) 5-40 wt. % of glass fillers and/or fibres
(D) 0.01-10 wt. % of the at least one additive
wherein the weight percentages (wt. %) are relative to the total weight of the polymer composition.

6. Plastic container for a cooling system, a heating system, an air intake system, an exhaust system, a pressure system or a fuel system, comprising a layer made of a thermoplastic polymer composition comprising a semi-crystalline semi-aromatic polyamide having a glass transition temperature (Tg) of at least 115° C. and a layer made from the thermoplastic polymer composition and at least one layer consisting of a polymer composition different from the thermoplastic polymer composition.

7. Plastic container according to claim 6, wherein the semi-crystalline semi-aromatic polyamide is a semi-crystalline semi-aromatic polyamide.

8. Component for a heating device or fuel system, wherein the component is a door handle, a door trim, a housing, a wall panel or a part thereof, a pump element, made of a thermoplastic polymer composition comprising a semi-crystalline semi-aromatic polyamide having a glass transition of at least 115° C.

9. Component according to claim 8, wherein the semi-crystalline semi-aromatic polyamide is a semi-crystalline semi-aromatic polyamide.

10. Use of a conduit according to claim 1, a in a cooling system, a heating system, an air intake system, an exhaust system, a pressure system or fuel system.

11. Use according to claim 10, wherein the cooling system, the heating system, the air intake system, the exhaust system, the pressure system or the fuel system is part of an automotive engine.

12. Use according to claim 10, wherein the container or conduit is in direct contact with hot air, water, cooling liquid, oil, or fuel

13. A heating system, a cooling system, an air intake system, an exhaust system, a pressure system or a fuel system comprising a conduit according to claim 1.
